(19) United States
(12) Patent Application Publication
(10) Pub. No.: US 2006/0171412 A1
(43) Pub. Date: Aug. 3, 2006

(54) Non-linear reception method and apparatus

(76) Inventor: Emmanuel Kanterakis, North Brunswick, NJ (US)

Correspondence Address: EMMANUEL KANTERAKIS, 740 Hoover Drive, North Brunswick, NJ, 08902, US

(21) Appl. No.: 11/328,852

(22) Filed: Jan. 10, 2006

Related U.S. Application Data
(60) Provisional application No. 60/643,664, filed on Jan. 13, 2005.

(51) Int. Cl. H04J 15/00

(52) U.S. Cl. 370/464

(57) ABSTRACT

A family of Multi-User Detector (MUD) structures is disclosed which allow for approximate linear and non-linear MMSE receivers in the presence of multipath propagation. A combination of linear and non-linear MUD structures provides substantial gains over their conventional linear counterparts. Long time span MUD detectors are disclosed which preserve time diversity gain processing gain in the presence of high rate Forward Error Correction (FEC) coding.

### RELATED APPLICATIONS

This application is related and claims the benefits of U.S. provisional patent application APPL No. U.S. 60/643,664 FILLING DATE Jan. 13, 2005 and entitled “Combined Linear and Non-Linear Interference Cancellation in DS-CDMA Systems”. The content of this provisional application is incorporated herein as reference.

### BACKGROUND OF THE INVENTION

1. Technical Field

The present invention related to an improved interference cancellation method for use in communication systems employing a variety of communications techniques such as DS-CDMA and OFDMA. The same technique can be used in other multiple access multi-channel communication techniques where, a linear operator, i.e., a linear matrix transformation, can describe the communications medium from the transmitter(s) to the output of the receiver demodulators, including the modulating functions and the channel. Though, these types of systems are mainly found in multi user environments, a single user can also use multiple channels and in essence operate, as would multiple users in transmitting its data. The invention disclosed here would apply to those systems in the same way as well. Examples of such a systems are DS-CDMA systems employing Multicode waveforms, MIMO systems and diversity reception systems where a receiver receives data from physically substantially separated in distance (beyond a carrier wavelength) transmitter antennas.

2. Background Art

Today's state of the art communication systems operate in the presence of self or multiple user interference. This has the effect that the rate each user can support becomes a strong function of the ratio of its own power to the powers transmitted by interfering users. In the uplink of a wireless cellular communication system employing a DS-CDMA technology, each user concurrently and independently transmits data to one or more Base Stations (BSs). The modulating waveforms used by the different users are in general not orthogonal to each other when they arrive at the Base Station antenna. This generates cross interference terms from interfering user transmissions to a linear receiver that is trying to receive the data from any specific transmitting user. Same situation arises in OFDMA systems where each user, though using waveforms that are supposed to be orthogonal to waveforms used by other users at the same time, clock inaccuracies, modulator waveform approximations and Doppler effects among others can render those waveforms as non orthogonal when they are received at a Base Station. In MIMO systems, multiple streams of data are transmitted from a number of antennas to multiple antennas of one or many users at the same time. These multiple streams are mixed together by the channel and need to be separated at the receiver. The mixing operation creates cross-term interference between the different streams, and the techniques disclosed here are directly applicable in removing or otherwise constructively using those cross interference terms in estimating the transmitted data steams.

Often, these receivers are called Multi-User Detectors since they are estimating the transmitted data from many users or data streams being received at the same time or Interference Cancellers where the cross term interference from user to user is removed. The reception method here uses in part techniques described in the paper “Multistage Linear Receivers for DS-CDMA Systems” by Shimon Moshavi, et all; published on January 1996 on the International Journal of Wireless Information Networks. The techniques described in the paper deal with linear reception techniques only and no provisions are made for any non-linear operations.

Non-linear multi-user receiver structures have been proposed before. For example, a CDMA non-linear multi-stage interference canceller receiver has been described in a journal paper published on February, 1998 IEEE Transactions on Communications paper titled “Improved Interference Cancellation for CDMA”, by Dariush Divsalar et all. The structure described in that paper is of a subtractive interference canceller type, where the interference for each user is regenerated and removed from the total received signal waveform. The method further relies on using the Matched Filter estimates to start a multistage interference cancellation process. The drawbacks of that method is a) the Matched Filter does not provide reliable enough estimates of the transmitted data in order to support efficient interference cancellation in subsequent stages, and b) the structures used are rather complex since they require the explicit estimation of the interference for each user before those interference components are removed from the received signal.

### SUMMARY OF THE INVENTION

A family of Multi-User Detector (MUD) structures is disclosed which allow for low complexity suboptimum linear and non-linear receivers in the presence of multipath propagation and other transmitter or channel impairments. A combination of linear and non-linear MUD structures provides substantial gains over their conventional linear counterparts. Non-linear MUD as shown here can provide substantial gains since these detectors can remove the effects of noise components from the estimated data when the reliability of the data decision variables is high. Knowledge of the background noise variance and system loading is required. Other novel linear MUD detectors are disclosed which preserve time diversity gain processing gain in the presence of high rate Forward Error Correction (FEC) coding. These MUD detectors can be used in systems, which utilize repetition coding with interleaving to spread in time symbol information for additional time diversity gain. Significant gains can be obtained when allowing the system to operate at higher error correction coding rates without sacrificing time diversity.

### BRIEF DESCRIPTION OF THE DRAWINGS

FIG. 1 shows a general structure of the proposed non-linear multi-user receiver based on a non-linear multi-stage structure.

FIG. 2 shows a schematic diagram depicting the soft buffering and timing control module before regenerating the received signal.

FIG. 3 shows a general structure of the proposed non-linear multi-user receiver based on a non-linear multi-stage structure with soft buffering and timing control to realign estimated data timing before the regeneration modules.

FIG. 4 shows an alternative general structure of the proposed non-linear multi-user receiver based on a non-linear multi-stage structure with soft buffering and timing control to realign estimated data timing before the regeneration modules.

FIG. 5 shows the proposed preferred linear multi-user receiver structure that is based on a multi-stage structure.

FIG. 6 shows a general structure of the proposed multi-user receiver that incorporates repetition coding with interleaving and multi-user detection, which has repetition coding and interleaving as an integral part of the multi-user detection process.

FIG. 7 shows a general structure of part of a stage in the multi-user receiver structure, which shows the process of de-interleaving, combining, repetition coding and interleaving as part of the detection and regeneration processes performed within each stage.

FIG. 8 shows a general Matched Filter bank at a Base Station receiver.

### DETAILED DESCRIPTION OF THE PREFERED EMBODIMENT

Novel methods for linear and combined linear and non-linear receiver in a multi-access environment are disclosed.

One of the ideas of this invention is to optimally combine Linear and Non-Linear MUD/Interference-Cancellation techniques for reduced hardware cost and increased system capacity. The method will be described in the context of a BS receiver. The method is however, also directly applicable to receivers in the User Equipment (UE). The difference is that the NodeB receives in the presence of interference caused by UEs transmitting on the Uplink whereas at the UE side, the UE needs to receive in the presence of interference cause by its own and other BSs transmissions. The UE complexity and information required about the interfering signals, though an issue, advantage can be taken form the fact the UE only receives signals from a small number of BSs.

The notation here is to use G to signify the matrix of received modulating waveforms at the BS having non-negligible power. Then, the received signal vector r at the BS can be expressed as:
r=Gd+n, (1)
where, d is the vector of transmitted data by all users for all times, and n is the corresponding background noise vector whose components are iid gaussian random variables of zero mean and variance N₀. In CDMA systems, G will contain all the spread spectrum codes used by all users along with their multipath components. In the case of OFDMA systems, G will contain complex sinewave waveforms transmitted by different users, where each user, most possibly transmits a subset of the total set of sinewave waveforms available per time interval. The system configurations defined by EQ. 1 can describe any linear communication system. Therefore, the techniques presented here apply to any linear system where multiple data are transmitted at the same time and they interfere with each other either. This interference can be due to various reasons such as their modulating waveforms not being orthogonal to each other or due to channel filtering. Define the matrix R such that,
R=G⁺G, (2)
be the cross-correlation matrix between received modulation waveforms, the Linear MMSE detector for the data in EQ. 1 can be expressed as
d_{MMSE}=L_{MMSE}r, (3)
where,
L_{MMSE}=[R+N₀I]⁻¹G⁺ (4)

G⁺r is the Matched Filter estimate of the transmitted data and N₀ is the background noise power spectral density. It has been shown before, that a simple structure that provides sub-optimal estimates of d_{MMSE} is given by

$${d}_{MMSE} = {\sum }_{i = 0}^{{N}_{s} - 1} {w}_{i} {R}^{i} {G}^{+} r \qquad ( 5 )$$

for some selected coefficients wᵢ and number of stages Nₛ. The receiver structure dictated by EQ. 5 has been patented under the U.S. Pat. No. 05,757,791. It is one of the objects of this invention is to use structures as defined in U.S. Pat. No. 05,757,791 to provide for a non-linear multi-stage multi-user communication receiver which when used after a linear multi-user communication receiver will provide additional gains in system performance.

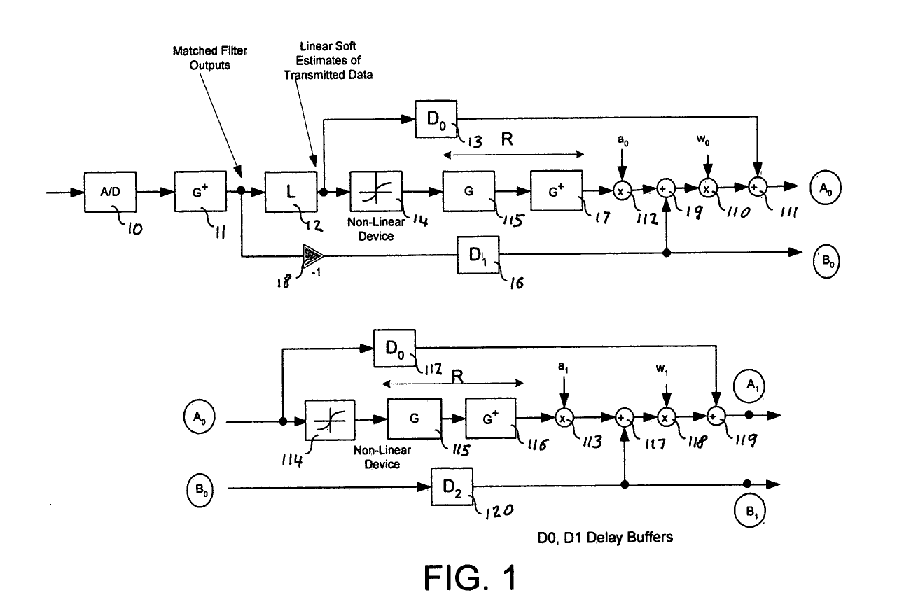

Let the operation defined by L denote a linear multi-user detector. Then, the method disclosed here could be presented as shown in FIG. 1. Additional stages may be added for improved reception performance. Each additional stage will be identical to the one between points (A0, B0) and (A1, B1). The above structure may be almost completely implemented with modules defined by operators G, G⁺ and some buffers.

There are certain similarities between the MUD shown in FIG. 1 and the one proposed by Divsalar. In contrast to the Divsalar method, the disclosed MUD receiver here has a number of major differences, which make it, more optimal and much less complex. In particular, two major differences are: a) a linear multi-user receiver is used after the Matched Filter in order to provide better (than the Matched Filter) linear estimates of the transmitted data, and b) the multistage structures are not of interference cancellation type, rather they are linear operations defined by the cross-correlation matrix between the received modulation waveforms and are implemented on line as a product of the matrices G⁺ and G. As in the case of Divsalar, a non-linear detector is used at each stage in estimating the received data. These types of non-linear detectors are commonly used in practice and provide an MMSE estimate of the transmitted data. Due to its MMSE nature, the detector requires knowledge of the total interference power.

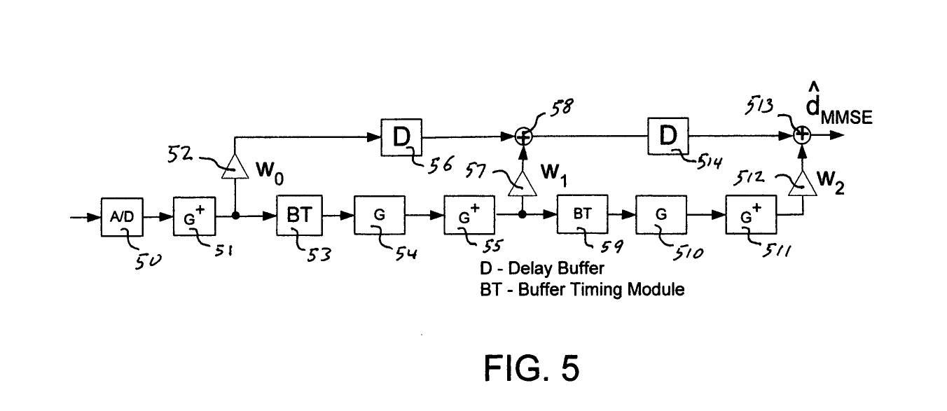

The non-linear MUD detector proposed here will be described when assuming the transmitted data are QPSK modulated. Minor alterations will be needed for other more general QAM modulation schemes. As shown in FIG. 1, the received signal waveform, after being A/D converted by A/D converter 10, is processed by a bank of Matched Filters defined by operator matrix G⁺ in module 11. The output decision variables from the Matched Filter bank are input to a Linear Detector 12, denoted by matrix L. This linear detector can be constructed in many different ways and there are exist numerous proposals of linear detectors. For the purpose of this disclosure, any linear MUD detector is applicable. The overall performance of the proposed non-linear MUD detector will however greatly depend on the performance capabilities of this detector. A simple but efficient linear MUD detector is shown in FIG. 5 and will be described later. The output of the linear MUD detector is a better estimator of the transmitted data than the output of the Matched Filter bank. The output of the linear MUD detector is then passed through a bank of non-linear devices 14. This bank of non-linear devices alters the amplitudes of the real and imaginary components of its input signals in a non-linear way according to their reliability measure. A non-linear function that is often used in QPSK modulated signals is that of a normalized arctan (ax) function. If the inputs to the non-linearity are deemed to be reliable, by controlling the parameter a, the arctan (ax) can be made to have a steeper slope at x=0 than when the inputs are not deemed as reliable. This in essence controls how much noise is removed from the inputs according their reliability measure. For example, when the inputs are decision variables of data that are known to be either of the value +1 or −1 and its are deemed reliable, then the parameter a will be set to a high value so that most of the output values of the non-linear detectors will be of +1 or −1 value. If the data are deemed as unreliable, the parameter a is set to a small value thus leaving the outputs be the same as their input counterparts unaffected to within a constant multiplicative value. For the case when higher QAM modulation schemes are used, the non-linearities look like staircases with smoother or steeper transition steps. In particular, these staircases are made of the sum of shifted arctan (ax) functions, with the parameter a again controlling the steepness of the transitions of the resulting function. The processed by the nonlinearities variables are consequently used to regenerate an estimate of the received Matched Filter outputs. Remodulating the outputs of the nonlinear devices with the known modulation signals as used by the users to transmit their data and summing them provides for an estimate of the received signal at the antenna point. In the general case the channel filters the transmitted modulation signals, estimates of these filtered modulation signals are used as well when remodulating the outputs of the nonlinear devices. This is denoted by the operation of matrix G in 15. Processing the outputs of 15 with G⁺ as in 17 will result to an estimate of the data part at the output of the Matched Filter 11. This estimate can then be weighted by the multiplier vector a₀ before added to a negated by 18 delayed by 16 vector output of the Matched Filter 11. The resulting output of vector adder 19 will be a negative estimate of the interference as seen at the output of the linear MUD detector 12. This interference error estimate is then appropriately scaled by weight vector w₀ before being added to the delayed by delay device 13 output of 12. The idea is to remove a substantial portion of the interference from the output of 12. In general, the outputs of vector adder 111 will be better estimates of the received data than the outputs of the linear MUD detector 12. This refinement process can be repeated again as shown in the stage following the adder 111. Since the outputs of 111 are now better estimates of the transmitted data, their reliability will also be higher and thus the nonlinear devices in 114 can be made steeper in order to provide estimates closer in amplitude to the ones transmitted. The process of estimating the interference vector and subtracting it from the refined data estimate vector at the output of 111 is similar to the one before. The only changes are the values of the weight vectors that need to be adjusted according to the newly acquired better data estimates.

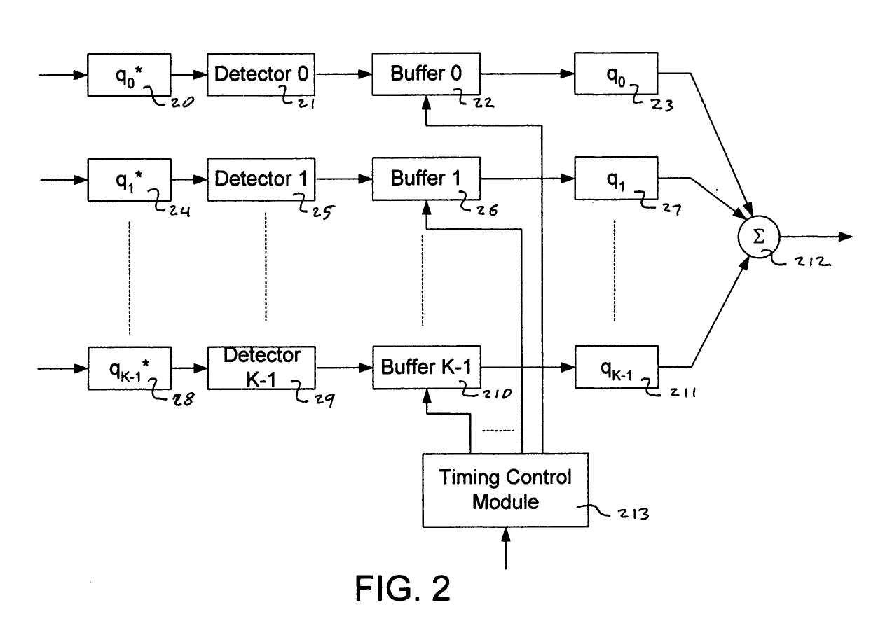

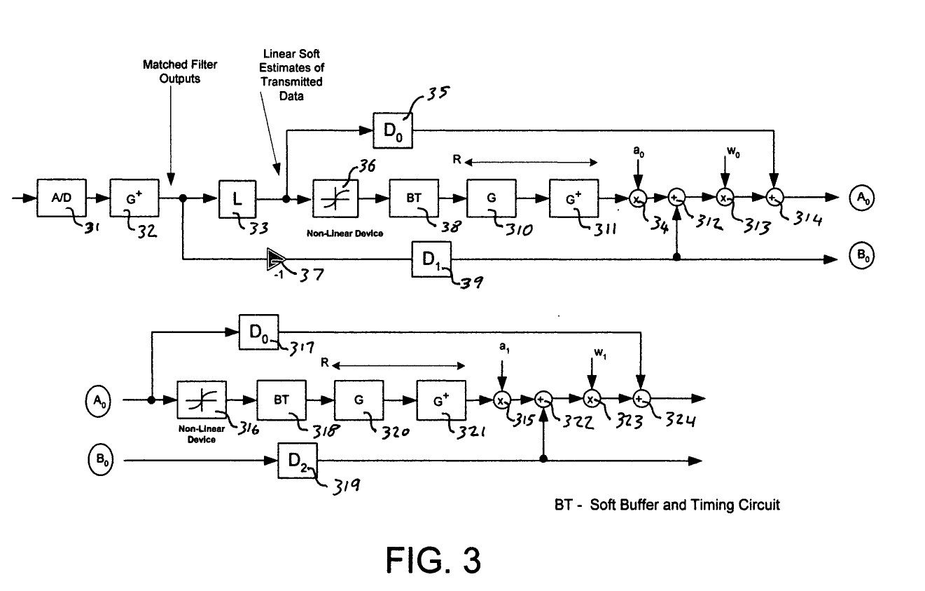

Another object of this disclosure is to align the estimated data at the input of each stage in order to correctly regenerate the received signal waveform. It is the likely scenario that received data from different users arrive at the Node-B asynchronously. Due to the asynchronicity of the data symbols, decisions on data arriving from different users are made at different times. This complicates the use of the received data estimates during the regeneration process. The timing offset effects due to lack of synchronicity are more pronounced if the data rates between different UEs are also different. In order for the received signal vector to be regenerated, a buffer that holds the estimated data is required. The interval covered by the waveform of any data symbol x can be regenerated only if all the symbols whose waveforms overlap with that of x have been demodulated as well. Since they are demodulated at different times, a buffer is required to hold the values of all the data symbols whose transmitting waveforms overlap with that of x. Furthermore, the timing of when a symbol was demodulated and when it should be inserted when regenerated needs to be coordinated between all demodulated symbols of all other users. The required buffering and timing control circuits are shown in FIG. 2. As shown in FIG. 2, the outputs of the Matched Filter bank, which includes demodulators 20, 24 and 28, are detected by detector devices 21, 25 and 19, respectively. The outputs of these detector devices are not necessarily aligned in time and in the case of different data rates used by different users, the alignment of these outputs changes all the time. The bank of buffers as denoted by 22, 26 and 210 are used to store the outputs of the detector bank until there enough information stored in the buffers to allow for the regeneration process to proceed. The rule is that a data estimate cannot be remodulated unless all the interfering symbols that interfered with it are demodulated and at least remodulated in part as well. The timing control module 213 controls the overall timing process. Once all the decision variables or estimate of the transmitted data are aligned, the modulator functions defined by the bank of devices 23, 27 and 211, remodulate these data estimates. The summer 212 sums the outputs of the modulators to generate an estimate of the received waveform at the receiver antenna point. The required buffering process may also be described in relation to FIG. 1 and shown in FIG. 3. In FIG. 3, two stages of non-linear processing are shown only. Buffers and timing modules need be inserted before all instances of the regenerating module G as shown by device modules 38, and 318 and denoted as BT.

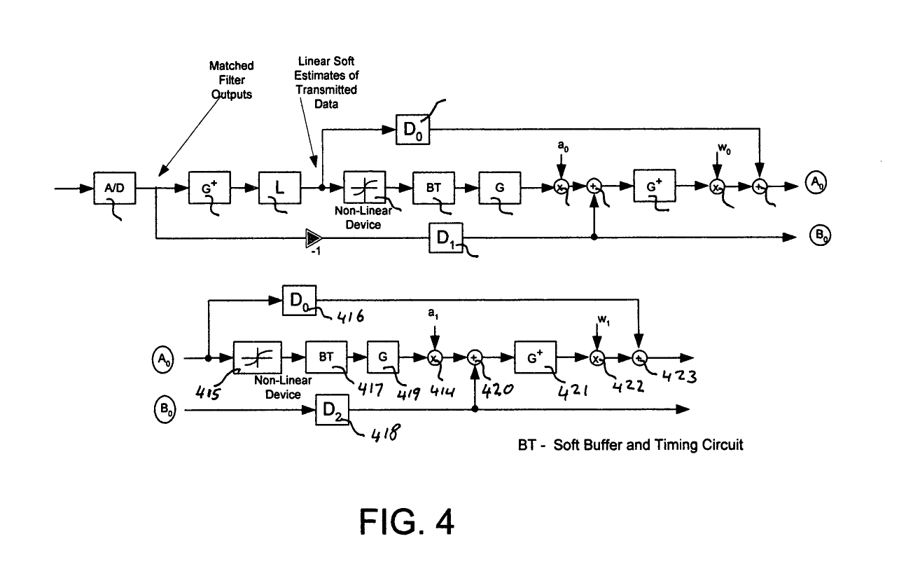

The structures shown in FIG. 1 and FIG. 3 may be structured in a slightly different way for the same level of complexity and performance. These structures are shown in FIG. 4.

In FIG. 4, the received signal at the antenna point is estimated rather than the outputs of the Matched Filter bank as in FIGS. 1 and 3. In FIG. 4, a scaled version by multiplier vector a₀ in 44, of the output of the regenerating device 49 is added to a negated and delayed by 48 received at the antenna point signal vector. The output of adder 410 is now a negative estimated version of the undemodulated interference. The module 411 is then used to demodulate this interference estimate, a weighted by w₀ version of which is then added to the delayed output of the linear MUD detector 43. In for properly selected weights, the output estimate of multiplier 412 is in general a good estimate of the interference at the output of linear MUD detector, which will then render the output of adder 413 a better estimate of the transmitted data that that of the linear MUD detector 43. The refinement process just described can again be repeated by refining the data estimates at the output of adder 413. In essence, the output of 413 now plays the role of the linear MUD detector output 43. The weight vectors a₁ and w₁ are now selected according to the additional reliability gained at the first stage.

The preferred structure for the linear MUD detector estimator L is shown in FIG. 5. A similar structure is also shown in U.S. Pat. No. 5,757,791 where, additionally the buffering structures have being incorporated. Here, the receiver input is A/D converted by A/D converter 50 and the demodulated by the Matched Filter bank G⁺ 51. The detected output of the Matched Filter bank 51 is weighted by the weight vector w₀ and delayed by delay bank 56. The detected output of the Matched Filter bank 51 is also buffered 53 in order to provide the necessary timing alignment needed by the regeneration module G 54. The output of the regeneration module 54 is re-demodulated by the demodulator bank G⁺ 55. The output of 55 is the weighted by weight vector w₁ and added to the output of the delay bank 56. The outputs of adder 58 are now better estimates of the transmitted data than the outputs of the Matched Filter bank 51. The next stage processing is identical to that in the previous stage with the exception that a different set of weights are now used. An optimum set of weights exists for each stage and ways to determining them have been published in the open literature as well as in the U.S. Pat. No. 5,757,791.

Another object of this invention is to disclose structures, which allow communication systems which use multi-user detectors to operate at high error correction coding rates while retaining most of the time diversity benefits that lower rate error correction codes provide. This is achieved by implementing repetition coding and interleaving at the transmitter and using multi-user detection structures at the receiver to harness the benefits of time-diversity coding while maintaining all the multi-user detection benefits as if the transmitted symbols were not repetition coded. Repetition coding as disclosed here needs to be implemented after any error correction coding and interleaving of the encoded data. Most DS-CDMA and OFDMA systems currently use forward error correction (FEC) coding to improve the system performance in the presence of multipath and multi-user interference. In fact, both DS-CDMA and OFDMA systems operate very poorly when sufficient FEC coding is not used. In DS-CDMA, FEC coding is mainly used to combat multi-user interference, and in general, the lower the code rate the better the system performance. FEC coding also serves in providing time diversity in multipath fading channels. Since an uncoded symbol is in some sense spread over a number of coded symbols after interleaving, the information in the uncoded symbol is spread over a number of coded symbols, which due to the channel coder interleaver are transmitted at different times. When the channel coherence is shorter than the interleaver span, FEC coding can provide the system with considerable diversity gain.

When a Multi-User Detector (MUD) is used, the multi-user interference is reduced, thus one of the main reasons for including FEC coding is partially being removed. It has been demonstrated (Milstein et al) that in systems, which use MUD, there is an optimum FEC rate, which is different than in systems without MUD. In general, the more effective the MUD detector is, the less FEC coding is needed. The multi-user effectiveness is in main part dictated by the processing gain of the transmitted symbols. Therefore, it is beneficial to keep the processing gain high as to harness large MUD gains. There is however, a point at which the MUD gains obtained by increasing the processing gain are lower that the FEC losses caused by the reduction in coding gain. The reduction in coding gain is caused by both the increase of the code rate and the decrease in time diversity gains which are inherent in FEC coding. Clearly, the optimum FEC coding rate is a function of the type of the MUD, the channel coder used and the channel itself.

Time diversity gains can only be obtained by transmitting the same data information at different times. However, any time diversity scheme will reduce the processing gain and t when the MUD operates on a symbol-by-symbol basis, the gain of the MUD. It is one of the objectives in this invention to disclose a MUD, which operates on a multi-symbol basis, and in particular on a frame-by-frame basis where a frame here is defined as the longest time-diversity interleaving frame in the system.

A time diversity scheme that still retains the notion of processing gain is repetition coding. In repetition coding, a symbol is segmented into shorter symbols, which after interleaved are transmitted at different random times. At the receiver side, the decision variables from each of the segments are combined to form a single decision variable for the transmitted symbol. Thus, the processing gain of the symbol is preserved. Here, a MUD is disclosed which uses this repetition coding scheme to retain its operating processing gain and thus achieve its maximum MUD gain. Since a symbol is transmitted at different times, the MUD should have the ability to combine the multiple symbol segments received at different times within an interleaving frame and decouple these multi-segment symbols from multi-segment symbols received from other users. Since each user has its own time-diversity interleaver frame and not synchronized with the time-interleaver frames of other users, buffering for longer than a single time-diversity interleaver frame span will be needed in order to collect all the coupled symbol segments from all users for each particular user's time-diversity interleaver span.

Operating on an interleaver frame basis means that coupling between symbols from different users over the span of at least one interleaver frame will need to be removed (de-coupled). This necessitates the inversion of a coupling matrix whose dimensions are as long as the longest coupling between time-diversified symbols from all users. Clearly, this can be a very large matrix, and its direct inversion is neither desirable nor efficient for most existing processing devices. Smaller matrices are possible to be formed for each symbol for each user; however, inverting a matrix for each symbol for each user is still not a computationally desirable alternative. A MUD structure that has previously been disclosed by the inventor can be reconfigured to operate with time-diversified symbols. In particular, the mathematical formulation and solution definition is still the same. In its implementation structure, additional particular modules will be needed in order to make the application of the mathematical formulation possible. In general, the composite received signal at a Base Station (BS) due to transmissions from different UEs, can be defined as a linear matrix system of equations given by
r=GPs+n (6)
where, s is the vector of transmitted FEC coded and interleaved by the channel interleaver symbols by all users for all times, G is a matrix holding the filtered by the channel transmitted modulation signal waveforms (vectors), P is a time diversification matrix which implements repetition coding and interleaving, and n is the corresponding background noise vector. The repetition coding and interleaving matrix P is a sparse matrix of whose non-zero elements are all ones and it serves in distributing a particular element in vector s to one or more places in vector d, where d=Ps, and where different elements in vector s do not map to the same element in vector d. The matrix P performs the function of both the repetition coding and interleaving for all symbols for all users for all times. The vector d therefore, holds all diversified user symbols for all users as its elements at different entries.

With the product matrix Q=GP representing the composite filtered code waveforms received from all users, the corresponding correlation matrix R defined by R=Q⁺Q, holds all the cross correlation values for all diversified symbols for all users for all times. With EQ. 6 expressed as
R=Qs+n, (7)
the linear MMSE detector for the symbols s is given similarly to that in EQ. 3 by
s_{MMSE}=L_{MMSE}r, (8)
where,
L_{MMSE}=[R+N₀I]⁻¹G⁺ (8)
and where, N₀ is the background noise power spectral density. As shown in the aforementioned publication, a simple structure estimating L_{MMSE} is given by

$${s}_{MMSE} = {{\sum }_{i = 0}}^{{N}_{s} - 1} {w}_{i} {R}^{i} {G}^{+} r . \qquad ( 9 )$$

Expanding EQ. 9, results in

$${S}_{MMSE} = {\sum }_{i = 0}^{{N}_{s} - 1} {{w}_{i} ( {Q}^{+} Q )}^{i} {G}^{+} r = {\sum }_{i = 0}^{{N}_{s} - 1} {{w}_{i} ( {P}^{+} {G}^{+} GP )}^{i} {P}^{+} {G}^{+} r . \qquad ( 10 )$$

The above expression dictates that the received vector r is first processed by the Matched Filter bank defined by G⁺ and then by the time de-diversification matrix P⁺. In essence, P⁺ collects and sums all the decision variable components obtained by matching to the vectors of the time diversified elements of each symbol for all users for all times. The transmitter/channel/receiver process is then repeatedly applied to the resulting decision variables as dictated by the processing of matrix R. The resulting vectors from each additional application of R are algebraically combined to form the final decision variables for the transmitted symbols.

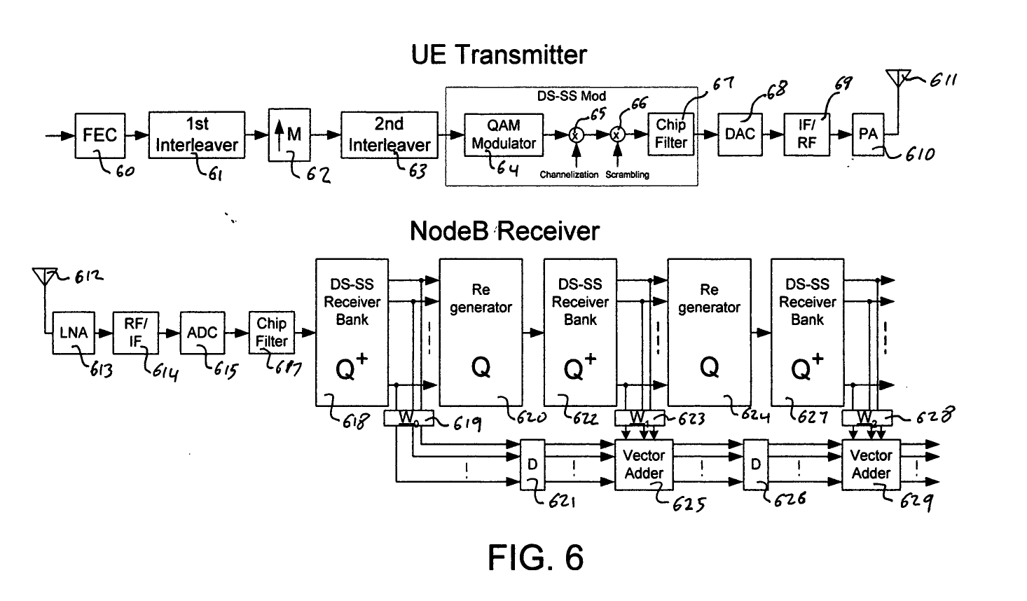

The overall system as described above for both the user transmitters and Base Station receiver is shown in block form in FIG. 6. At the user transmitter side the information data to be transmitted are first FEC coded 60 and then interleaved by the channel interleaver 61 (1st interleaver). The resulting coded data is then repetition coded by block 62 shown by an up arrow and the value of M signifying that the input to the block data is repeated M times. The number M can be different from user to user, and it could as well be set to unity. The 2nd interleaver 63 is used in case repetition coding is used as well and interleaves the resulting repetition coded symbols. The resulting coded interleaved data vector is applied to an appropriate modulator 64 before transmission. Here the modulator 64 shown is a linear QAM modulator, which includes the channelization 65 and scrambling 66 functions for DS-CDMA transmission. The resulting DS-CDMA waveform is filtered 67, D/A converted 68 and transmitted using known IF/RF transmission techniques shown with the D/A converter 68, the IF/RF 69, the power amplifier 610 and antenna 611. At the Base Station side, the received over the RF/IF 614 is A/D converted 615, chip filtered 617 and then passed by the bank of Matched Filters as dictated by matrix G⁺ and the time-de-diversification matrix P⁺ to implement the overall processing dictated by matrix Q⁺ 618. The repeated application of R=Q⁺Q to the Matched Filter output vector is shown as a chain of identical processing stages 620, 622 and 624, 627. The vector outputs of these stages are then algebraically combined as shown and defined in EQ. 10 and depicted by multiplier banks 619, 623 and 628, delay banks 621 and 626 and vector adders 625 and 629. The delay buffers inserted in between stages account for the processing and transmission delays within each stage for different users. The weights can be computed by methods disclosed in previously published techniques. The basic approach relies on the minimization of the squared error at the output of the multistage structure given the output is known to the receiver. This is possible by periodically inserting pilot signals known to the receiver. By having enough pilots transmitted at different times, the structure can adapt to the changes of the channel and system loading. Closed forms expressions also exist for weights when the processing gain of the system is large while keeping the overall system loading fixed.

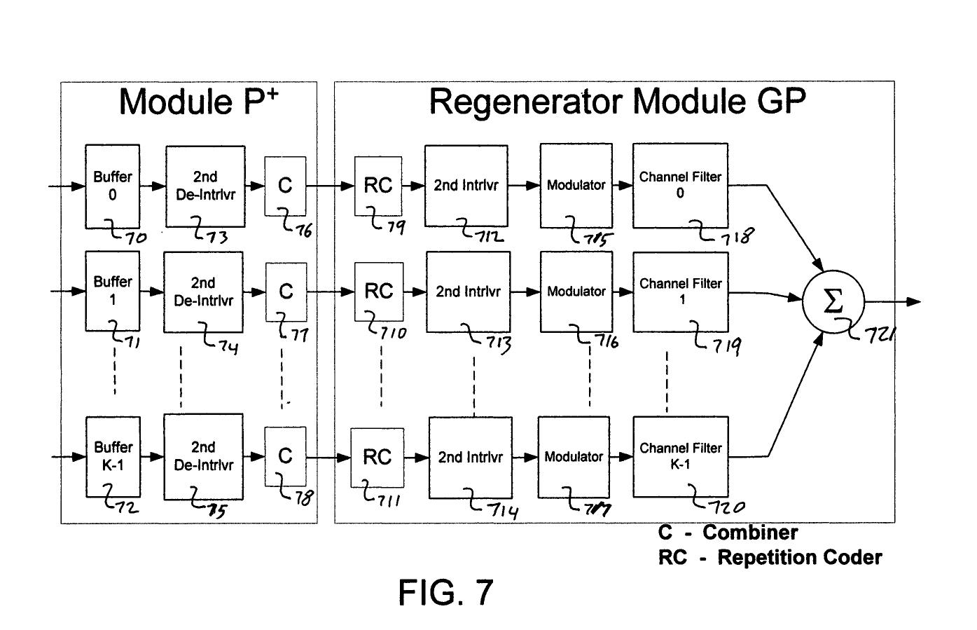

In FIG. 7, the module P⁺ and regeneration module GP are shown. Here, the decision variables from the previous stage are buffered as in 70, 71 and 72 until all the decision variables belonging to a given time-repetition coding frame for each corresponding user is collected. This buffered data is then de-interleaved by the corresponding to each user second de-interleaver as in 73, 74 and 75 and then combined to remove the repetition coding as in combiners 76, 77 and 78. At his point, the processing gain lost due to repetition coding at the user transmitters has been recovered. The process of regenerating the received signal waveform can begin by processing all the repetition-decoded frames. Note that a strict appropriate alignment of the frames belonging to different users needs to be maintained at all times. The data frames for all users will then need to be repetition coded by using repetition coders as in 70, 710 and 711, and interleaved as with interleavers 712, 713 and 714 and remodulated as with remodulators 715, 716 and 717, as it was done at the transmitter side. The resulting waveforms are then individually passed through the estimated for each user channel filters as in 718, 719 and 720 before being algebraically summed with summer 721 to form the regenerated signal estimate of the signal as received at the Base Station antenna point.

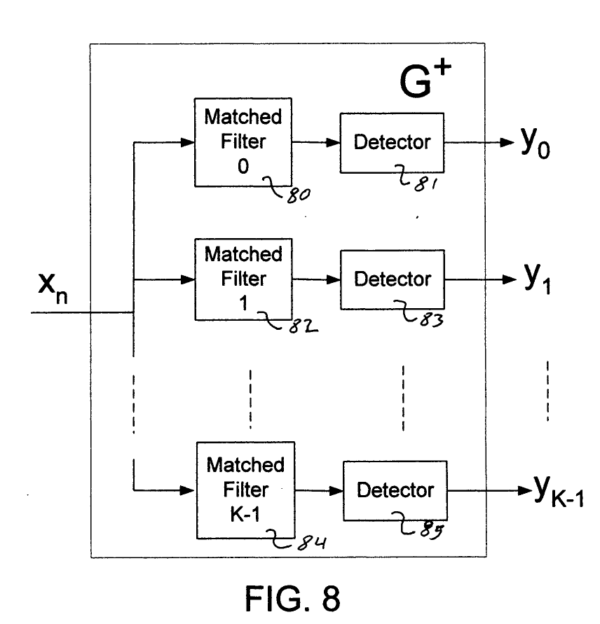

The operation of the matrix defined by Q⁺ is described with the help of FIGS. 7 and 8. In FIG. 7, the module P⁺ and regenerator module GP are shown. In FIG. 8, the module defined by matrix G⁺ is shown. The combination of the structures shown in FIGS. 7 and 8 constitute the structure of each stage of the disclosed linear MUD multi-stage receiver structure.

We claim:

1. A multistage receiver for extracting data embedded in a received signal having a plurality of channels and a respective plurality of modulation signals, with each channel having a modulation signal different from modulation signals of the other channels of the plurality of channels, said multistage receiver comprising:
demodulation means, for demodulating and detecting the plurality of channels embedded in the received signal as a plurality of detector-output signals, respectively;
detector-weighting means, coupled to said demodulation means, for weighting the plurality of detector-output signals with a plurality of detector weights to generate a plurality of weighted-detector signals, respectively;
first combiner-delay means, coupled to said detector-weighting means for delaying the plurality of weighted-detector signals to generate a first plurality of delayed-weighted signals;
first plurality of delay means coupled to said demodulation means for delaying the plurality of detector-output signals to generate a first plurality of detector-delayed signals, respectively;
first stage means, coupled to said first plurality of delay means, for modulating the first plurality of detector-delayed signals with a replica of the plurality of modulation signals of the plurality of channels, to generate a first plurality of signals, respectively, for combining the first plurality of signals as a first combined signal, for demodulating the first combined signal as a first plurality of demodulated-combined signals;
first weight means, coupled to said first stage means, for weighting the first plurality of demodulated-combined signals with a plurality of first weights, respectively, thereby generating a first plurality of weighted signals; and
first output-combiner means, coupled to said first combiner-delay means and to said first weight means, for combining the first plurality of delayed-weighted signals and the first plurality of weighted signals, respectively, thereby generating a first plurality of combined-output signals to extract the data.

2. A multistage receiver for extracting data embedded in a received signal having a plurality of channels and a respective plurality of modulation signals, with each channel having a modulation signal different from modulation signals of the other channels of the plurality of channels, said multistage receiver comprising in part of:
demodulation means, for demodulating and detecting the plurality of channels embedded in the received signal as a plurality of detector-output signals, respectively;
detector-weighting means, coupled to said demodulation means, for weighting the plurality of detector-output signals with a first plurality of detector weights to generate a plurality of weighted-detector signals, respectively;
first combiner-delay means, coupled to said detector-weighting means for delaying the plurality of weighted-detector signals to generate a first plurality of delayed-weighted signals, respectively;
first plurality of linear combining means coupled to said demodulation means for linearly combining the plurality of detector-output signals to generate a first plurality of linearly combined signals, respectively;
second combiner-delay means, coupled to said first plurality of linear combining means for delaying said first plurality of linearly combined signals to generate a second plurality of delayed-weighted signals, respectively;
linear detector-weighting means, coupled to said first plurality of linear combining means, for weighting said first plurality of linearly combined signals, to generate a plurality of linear detected weighted signals, respectively;
non-linear detection means, coupled to said linear detector-weighing means, for non-linearly detecting said plurality of linear detected weighted signals, to generate a plurality of non-linearly detected signals, respectively;
first stage means, coupled to said non-linear detection means, for modulating the plurality of non-linearly detected signals with a replica of the plurality of modulation signals of the plurality of channels, to generate a first plurality of signals, respectively, for combining the first plurality of signals as a first combined signal, for demodulating the first combined signal as a first plurality of demodulated-combined signals;
first output-combiner means, coupled to said first combiner-delay means and to said first stage means, for combining the first plurality of delayed-weighted signals and the first plurality of demodulated-combined signals, respectively, thereby generating a first plurality of combined-output signals, respectively;
first output-combiner weighting means, coupled to first output combiner means, for weighting said first plurality of combined-output signals, thereby generating a first plurality of combined-output weighted signals, respectively;
combining means, coupled to first output-combiner weighting means and second combiner-delay means, for combining said first plurality of combined-output weighted signals and said second plurality of delayed-weighted signals, thereby generating a first plurality of output signals, respectively, to extract the data.

3. A multistage receiver for extracting data embedded in a received signal having a plurality of channels and a respective plurality of modulation signals, with each channel having a modulation signal different from modulation signals of the other channels of the plurality of channels, said multistage receiver comprising:
demodulation means, for demodulating and detecting the plurality of channels embedded in the received signal as a plurality of detector signals, respectively;
plurality of de-interleaver means, coupled to said demodulation means, for de-interleaving each of the plurality of detector signals, thereby generating a plurality of de-interleaved detector-output signals, respectively;
plurality of de-interleaver-combiner means, coupled to said plurality of de-interleaver means, operating on each of the plurality of de-interleaved detector-output signals, respectively, for combining at least one of a series of said de-interleaved detector-output signals, thereby generating a plurality of detector-output signals respectively,
detector-weighting means, coupled to said plurality of de-interleaver-combiner means, for weighting the plurality of detector-output signals with a plurality of detector weights to generate a plurality of weighted-detector signals, respectively;
first combiner-delay means, coupled to said detector-weighting means for delaying the plurality of weighted-detector signals to generate a first plurality of delayed-weighted signals;
first plurality of delay means coupled to said demodulation means for delaying the plurality of detector-output signals to generate a first plurality of detector-delayed signals, respectively;
first stage means, coupled to said first plurality of delay means, for performing a repetition operation individually on each of the first plurality of detector-delayed signals, thereby generating a first plurality of repetition coded signals, for modulating said first plurality of repetition coded signals with a replica of the plurality of modulation signals of the plurality of channels, to generate a first plurality of signals, respectively, for combining the first plurality of signals as a first combined signal, for demodulating the first combined signal as a first plurality of demodulated signals, for de-interleaving each of the first plurality of demodulated signals as a first plurality of de-interleaved demodulated signals, and for combining at least one of a series of the first plurality of de-interleaved demodulated signals as a first plurality of de-interleaved combined signals thereby generating a first plurality of demodulated-combined signals;
first weight means, coupled to said first stage means, for weighting the first plurality of demodulated-combined signals with a plurality of first weights, respectively, thereby generating a first plurality of weighted signals; and
first output-combiner means, coupled to said first combiner-delay means and to said first weight means, for combining the first plurality of delayed-weighted signals and the first plurality of weighted signals, respectively, thereby generating a first plurality of combined-output signals to extract the data.
